(19) United States
(12) Patent Application Publication
(10) Pub. No.: US 2002/0081984 A1
(43) Pub. Date: Jun. 27, 2002

(54) System that customizes favorite radio stations for multiple users

(76) Inventor: Constance Liu, Cupertino, CA (US)

Correspondence Address: Constance Liu, 20397 Via Napoli, Cupertino, CA, 95014, US

(21) Appl. No.: 09/748,778

(22) Filed: Dec. 27, 2000

(51) Int. Cl. H04B 1/18; H04B 1/06

(52) U.S. Cl. 455/186.1; 455/179.1; 455/185.1; 455/345

(57) ABSTRACT

A typical car radio has favorite-station buttons for storing and selecting a driver's favorite radio stations. If a car has more than one driver, then it becomes difficult for each driver to fully enjoy the comfort these favorite-station buttons offer. For example, a father's favorite radio stations may not be his daughter's. Any sharing of the favorite-station buttons is likely to be confusing when more than one driver shares the use of the same car. The confusion is especially made worse when at least one of the drivers is handicapped by either a physical disability or by senility.

This invention has memory for storing radio station frequencies for access by more than one driver. Each driver is first uniquely identified, and the driver's identity is then used to make available for selection by the driver radio stations preset by this driver. This invention reduces confusion and increases comfort for those drivers who share a car.

### FIELD OF THE INVENTION

This invention has to do in general with a radio system to be operated inside a vehicle. An aspect of the invention relates to such a radio system that automatically makes available for selection pre-set frequencies of radio stations for each of the multiple drivers to the vehicle. As a practical advantage, this invention adds comfort to and reduces confusion resulting from the use of a car by more than one driver.

### BACKGROUND INFORMATION

Radios are commonplace inside vehicles such as cars, boats and planes. The audio information they transmit has served drivers and passengers tremendously by providing current events (e.g., news radio stations), entertainment (e.g., country and classical music radio stations) and audio meditation (e.g., religious radio stations). A typical car radio has multiple mechanical buttons associated with it to allow a user (usually a driver of the car) to pre-set the preferences for the radio stations to listen to. Once set, it becomes very convenient to the user for radio station selection because a particular preferred radio station may be tuned to by simply depressing one of the mechanical buttons.

A disadvantage of this car radio, however, rises when more than one driver uses the same car radio. For example, in the case of a “family car” where parents and young adults in the family share a car, the radio station preferences for each of the drivers to this car may be drastically different. In other words, the radio's pre-set stations for one driver may have been different from the desired pre-set stations for another. To change the pre-set settings whenever a driver enters the vehicle is also very cumbersome. In short, the more drivers there are to this “family car”, the more difficult it becomes for each driver to fully enjoy the comfort this radio station pre-set feature offers.

Another disadvantage is confusion. When more than one driver uses a car radio, a common solution is that the favorite-station buttons of the radio are shared. For instance, the father gets to pre-set the first three favorite-station buttons and the mother gets to pre-set the fourth and fifth buttons and the daughter gets the last button. This approach requires human memory and therefore is prone to mistakes. This is especially made worse when, for example, another two teenagers in the family also become eligible to drive the same “family car”, or further exacerbated when grandpa of the family also drives that car and that he is eighty years old with a memory loss problem.

Therefore, it is desirable to have a radio system inside a vehicle such as a car to allow each of the multiple drivers to pre-set his or her favorite-station frequencies for subsequent selection by the same mechanical buttons.

### SUMMARY OF THE INVENTION

Briefly, a vehicle radio apparatus and method are provided for allowing multiple users to customize their favorite radio station preferences. These favorite-station preferences are stored in the radio memory for subsequent user selection. A driver may make his station selection from his stored favorite-station preferences by depressing one of several mechanical buttons that are associated with the radio apparatus.

For a multi-driver vehicle, an identification system in the vehicle first uniquely identifies the driver entering the vehicle. The identification process may be accomplished by a number of ways including a His/Her switch located inside the vehicle, a remote-controlled transmission, or even a key insertion. Once the driver is identified, his favorite-station preferences previously stored in the radio memory will be accessed and become associated with the several mechanical buttons. Each driver in this multi-driver vehicle may have a set of favorite-station preferences stored in the radio memory different from that of another, but each set may become associated with the same several mechanical buttons once the ‘owner’ of that set is identified to have entered the vehicle.

Advantageously, the present invention reduces confusion and adds comfort to the drivers of the same vehicle in that a driver's favorite-radio-station preferences are automatically made available for selection when that particular driver turns on the radio. It is as if this driver is the only driver of the vehicle.

### BRIEF DESCRIPTION OF THE DRAWINGS

A better understanding of the present invention can be obtained by considering the following detailed description taken together with the accompanying drawings that illustrate preferred embodiments of the present invention in which:

FIG. 1 shows a typical appearance of a car radio; and

FIG. 2 shows a simplified functional diagram of the present invention including a vehicle micro-controller in accordance with the present invention.

### DETAILED DESCRIPTION OF THE PREFERRED EMBODIMENTS

With today's advances in technology, the design of specialized integrated circuits and programmable logic generally do not require the rendering of fully detailed circuit diagrams. The definition of logic functionality allows computer design techniques to design the desired logic and circuits. Additionally, vehicle micro-controllers are known to operate based on a desired flow chart diagram rendered into software. Accordingly, portions of the present invention will be described primarily in terms of functionality to be implemented by a vehicle micro-controller and other associated electronic components. This functionality will be described in detail with the associated flow chart diagram. Those of ordinary skill in the art, once given the following descriptions of the various functions to be carried out by the present invention will be able to implement the necessary micro-controller structure and logic for various logic devices or custom designed integrated circuits in suitable technologies without undue experimentation.

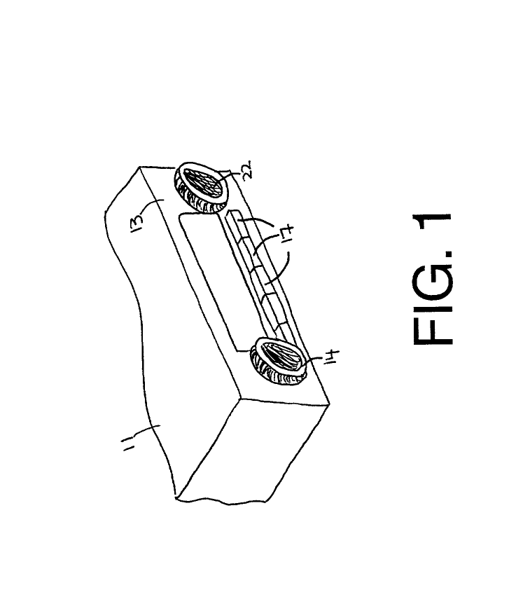

Now referring to FIG. 1, it shows a typical appearance of a car radio 11. An ON/OFF and a sound volume selection features are usually accomplished by the use of a knob 14. Sometimes additional features such as left/right speaker volume and bass/treble range adjustments may be activated by first pulling outward or pushing inward the knob 14. A desired radio station tuning frequency may be selected by the use of another knob 22. Typically, on a face 13 of the car radio 11, there are several mechanical push buttons 17. Each of these mechanical push buttons 17 is used to store and to select the tuning frequency of a preferred radio station. In short, after storing the frequency of a preferred radio station using one of the mechanical push buttons 17, a driver may subsequently cause the radio to tune to that previously stored radio station frequency by depressing that particular mechanical push button 17. The mechanism and method for such storage and selection are well known, and the details of which will not be elaborated here. A preferred embodiment of the present invention may take on the outside appearance of this typical car radio 11. Functionally speaking, however, each of the mechanical push buttons 17 of the present invention may be used to store and to select instead of one, but more than one station tuning frequency depending on the identity of the user.

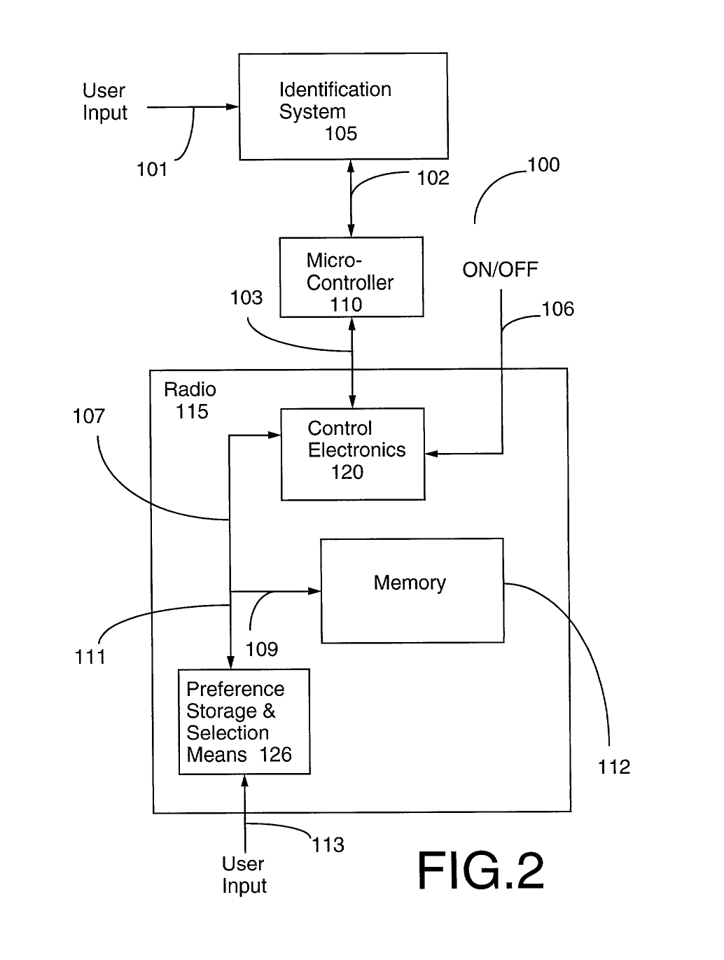

Referring now to FIG. 2, it shows a simplified functional diagram of a radio system 100 including a vehicle micro-controller 110 in accordance with the present invention. The radio system 100 includes an identification system 105, the vehicle micro-controller 110 and a radio 115. The micro-controller 110 is coupled with the identification system 105 via path 102 and couples to the radio 115 via path 103. User input is received by the identification system 105 via path 101, and user input is also received by the radio 115 via paths 106 and 113. The micro-controller 110 may or may not be a part of the radio 115, and if it 115 is not, it 115 usually has functions in addition to radio 115 control, for example temperature monitoring and control (not shown).

The identification system 105 is commonplace in today's vehicles. It 105 may be a His/Her toggle switch and related circuitry found in many cars where a toggle (user input via path 101) in “His” direction identifies one driver and a toggle in “Her” direction identifies another driver. Such identification may be used for temperature control in different portions of the vehicle internal compartment. Even with keys, differing notch-and-groove key patterns may be used to lock and unlock the same lock but each key pattern when inserted may be sensed to enable the present invention to distinguish one user from another. In the newer car models, biometrics such as voice or even fingerprint may be used for driver identification.

Also, in a car where a remote device (e.g., a keyless entry system) is used for locking and unlocking vehicle doors, uniquely-coded transmissions may be generated by this typical device to distinguish one driver from another. The car may have several such remote devices one for each driver of the car, and each device generates a unique transmission for door locking/unlocking and identification purposes. Alternatively, a remote device may have more than one button where each button controls the generation of one unique transmission to the car locking/unlocking and identification system. In other words, one driver may use button X on a remote device and another driver may use button Y on another remote device for locking/unlocking and identification purposes.

The information of the driver identity is then transmitted from the identification system 105 to the micro-controller 110 via path 102 whereby making the information available for use by the radio 115 via path 103. The radio 115 includes control electronics 120, preference storage and selection means 126 and memory 112. The driver identification information will be used by the radio 115 depending on the ON/OFF input via path 106 to the control electronics 120 of the radio 115. For example, if a user turns the knob 14 of FIG. 1 OFF, then the radio 115 would not process the driver identification information although such information is available in the identification system 105.

The preference storage and selection means 126 in a preferred embodiment includes half a dozen or so mechanical push buttons disposed on a face of the radio 115 similar to the prior art buttons 17 in FIG. 1. The radio station preference information as user input is stored into the memory 112 via paths 111, 109 for subsequent selection under the control of the control electronics 120 via paths 111, 107.

When the radio 115 is ON, a driver may provide user input via path 113 to either store or select preferred radio station frequencies using methods well known in the art. Since the current driver identity is received by the radio 115 from the identification system 105, the preference storage and selection information actuated by using the preference means 126 via path 113 is then associated with the current driver identity in the memory 112. For instance, a driver A saves a radio station frequency B through the preference means 126 (e.g., depressing a mechanical push button C for a few seconds while the station is being tuned to). The control electronics 120 will then process the information and will then preferably via firmware and in memory 112 link the radio station frequency B to the mechanical button C and the current driver identity received from the identification system 105. Subsequently, to select and tune to the previously-saved radio station B, the driver A after having been identified by the identification system 105, will actuate the preference means 126 (e.g., depressing briefly the mechanical push button C). The control electronics 120 will then retrieve from memory 112 the radio station frequency B that is linked to the matching current driver identity and the mechanical push button C and will then proceed to tune to the radio station frequency B.

As a result, the driver A storing or selecting a radio station frequency using a particular mechanical button of the preference means 126 is distinguishable from a driver D storing or selecting another radio station frequency using the same particular mechanical button. In other words, the driver A operates the preference means 126 as if he is the only driver to the car and the same is true for driver D.

The foregoing description of preferred embodiments of the present invention have been presented for purposes of illustration and description. They are not intended to be exhaustive or to limit the invention to the precise forms disclosed, and obviously many modifications and variations are possible in light of the above teaching. It is intended that the scope of the invention be defined by the claims appended hereto and their equivalents.

We claim:

1. A radio system in a vehicle for allowing multiple drivers to store, select and tune to preferred radio stations, said radio system comprising:
an identification system including a plurality of remote devices of a keyless entry system for the vehicle wherein each remote device being capable of generating a uniquely-coded transmission for generating a first current driver identity;
a vehicle micro-controller located in the vehicle and said vehicle micro-controller being operatively coupled to the identification system for receiving the first current driver identity;
a radio including preference means for receiving preferred station information for storage, memory for storing the preferred station information for storage, and control electronics for preferred station information processing and for receiving the first current driver identity from the vehicle micro-controller and linking in the memory the first current driver identity to the preferred station information for storage; and
the preference means further receiving preferred station information for selection and tuning and the control electronics being operatively configured to receive a second current driver identity from the identification system and further being configured to respond to the preferred station information for selection and tuning by selecting and tuning to the preferred station information for storage whose linked first current driver identity matching with the second current driver identity.

2. The radio system as claimed in claim 1 wherein each remote device has more than one trigger button wherein each button generates an identification transmission different from that of others.

3. The radio system as claimed in claim 1 wherein each remote device generates an identification transmission different from that of others.

4. A radio system in a vehicle for allowing multiple drivers to store, select and tune to preferred radio stations, said radio system comprising:
an identification system including a His/Her toggle switch located inside the vehicle for generating a first current driver identity;
a vehicle micro-controller located in the vehicle and said vehicle micro-controller being operatively coupled to the identification system for receiving the first current driver identity;
a radio including preference means for receiving preferred station information for storage, memory for storing the preferred station information for storage, and control electronics for preferred station information processing and for receiving the first current driver identity from the vehicle micro-controller and linking in the memory the first current driver identity to the preferred station information for storage; and
the preference means further receiving preferred station information for selection and tuning and the control electronics being operatively configured to receive a second current driver identity from the identification system and further being configured to respond to the preferred station information for selection and tuning by selecting and tuning to the preferred station information for storage whose linked first current driver identity matching with the second current driver identity.

5. A radio system in a vehicle for allowing multiple drivers to store, select and tune to preferred radio stations, said radio system comprising:
an identification system for generating a first current driver identity;
a vehicle micro-controller located in the vehicle and said vehicle micro-controller being operatively coupled to the identification system for receiving the first current driver identity;
a radio including preference means for receiving preferred station information for storage, memory for storing the preferred station information for storage, and control electronics for preferred station information processing and for receiving the first current driver identity from the vehicle micro-controller and linking in the memory the first current driver identity to the preferred station information for storage; and
the preference means further receiving preferred station information for selection and tuning and the control electronics being operatively configured to receive a second current driver identity from the identification system and further being configured to respond to the preferred station information for selection and tuning by selecting and tuning to the preferred station information for storage whose linked first current driver identity matching with the second current driver identity.

6. The radio system as claimed in claim 5 wherein the preference means includes a plurality of mechanical push buttons.
